(19) United States
(12) Patent Application Publication
(10) Pub. No.: US 2017/0192788 A1
(43) Pub. Date: Jul. 6, 2017

(54) BINARY TRANSLATION SUPPORT USING PROCESSOR INSTRUCTION PREFIXES

(71) Applicant: Intel Corporation, Santa Clara, CA (US)

(72) Inventors: Oleg Margulis, Los Gatos, CA (US); Jason M. Agron, San Jose, CA (US); Tyler N. Sondag, Santa Clara, CA (US)

(21) Appl. No.: 14/988,298

(22) Filed: Jan. 5, 2016

(51) Int. Cl. G06F 9/30

(52) U.S. Cl. CPC G06F 9/30181; G06F 9/30101; G06F 9/3001

(57) ABSTRACT

A processing system implementing techniques for binary translation support using processor instruction prefixes is provided. In one embodiment, the processing system includes a register bank having a plurality of registers to store data for use in executing instructions and a processor core coupled to the register bank. An instruction to be executed by the processor core is received. The instruction is associated with a binary translator operation to translate input instruction sequences to output instruction sequences. An opcode prefix referencing an extended register of the plurality of registers to be used during the binary translator operation. The extended register preserves a source register value of the plurality of registers.

### TECHNICAL FIELD

Embodiments of the disclosure relate generally to microprocessors and more specifically, but without limitation, for binary translation support using processor instruction prefixes.

### BACKGROUND

Binary translation is a process of translating an executable that is compiled for one instruction set architecture, such a legacy architecture, to object code for a new instruction set architecture or the same first architecture. Some systems that support binary translation introduce additional hardware structures in a processor core to support code optimization. These structures as well as other new architecture or hardware features of the processor core have to be exposed to an application level (e.g., outside world) or to a hidden (contained) world that is controlled by a vendor's CPU in order to be managed by the optimized code at runtime.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a block diagram of a processing device to support binary translation using processor instruction prefixes according to one embodiment.

FIG. 2 illustrates a system including a memory for supporting binary translation using processor instruction prefixes according to one embodiment.

FIG. 3 illustrates a flow diagram of a method for binary translation support using processor instruction prefixes according to one embodiment.

FIG. 4 illustrates a flow diagram of a method for extending general purpose registers using processor instruction prefixes according to one embodiment.

FIG. 5A is a block diagram illustrating a micro-architecture for a processor according to one embodiment.

FIG. 5B is a block diagram illustrating an in-order pipeline and a register renaming stage, out-of-order issue/execution pipeline according to one embodiment.

FIG. 6 is a block diagram illustrating a computer system according to one implementation.

FIG. 7 is a block diagram illustrating a system in which an embodiment of the disclosure may be used.

FIG. 8 is a block diagram illustrating a system in which an embodiment of the disclosure may be used.

FIG. 9 is a block diagram illustrating a system in which an embodiment of the disclosure may be used.

FIG. 10 is a block diagram illustrating a System-on-a-Chip (SoC) in which an embodiment of the disclosure may be used.

FIG. 11 is a block diagram illustrating a SoC design in which an embodiment of the disclosure may be used.

FIG. 12 illustrates a block diagram illustrating a computer system in which an embodiment of the disclosure may be used.

### DETAILED DESCRIPTION

Techniques for binary translation support using processor instruction prefixes are disclosed herein. Binary translation allows for the execution of binary codes complied for a first architecture (e.g., legacy architecture) to be run on a second architecture (e.g., next generation architecture) or the same first architecture. Computer programs are typically complied into the binary codes using a specific instruction set for a particular processor architecture. In many situations, the processor may use the specific instructions to access hardware (e.g., general purpose registers (GPR)) implemented in certain instruction set architectures (ISA), such as an x86 architecture. In certain situations, this causes a problem when a next generation of processors is introduced that may include new internal hardware structures, such as an extended set of registers. For example, significant engineering and monetary resources may be needed for systems that implement binary translation to help support computer programs compiled with legacy processor architecture to make use of hardware in the next generation processor architecture.

Several approaches exist to take advantage of new hardware features implemented in or associated with the new processor. In one approach, a control register (CREG) interface may be used to change the general behavior of a processor when it is executing the computer programs complied using the legacy architecture. However, this approach is inefficient, as the CREG interface is usually inherently slow. In another approach, the processor may include an alternative instruction set that co-exists with the legacy (x86) instruction set. In this approach, although the alternative instruction set is capable of accessing all necessary hardware, the approach can be costly and involve significant engineering effort because it requires a duplication of certain critical parts of the processor, such as front-end logic for the processor core.

Embodiments of the present disclosure provide processor instruction prefixes for accessing new processor functionality to support binary translation of a set of input instruction sequences to output instruction sequences. In one embodiment, an instruction received at a processor includes an opcode prefix. The opcode prefix includes a plurality of bits that may be used to expose the new hardware functionality to a binary translation application. This new hardware functionally may include, but not limited to: accessing an extended set of processor resources, such as an extended set of GPRs; a non-destructive operation (e.g. where a source register used in some type of optimization operation is to be preserved; reordering hardware for tracking an out-of-order execution for a sequence of instructions that may have been reorder so that they can be executed more efficiently at runtime; and predication hardware to control the conditional execution of some instructions for optimized code used by the binary translation application. In alternative embodiments, the instruction prefix may be used to expose other new functionally to support binary translation and other types of optimization for the legacy binary codes.

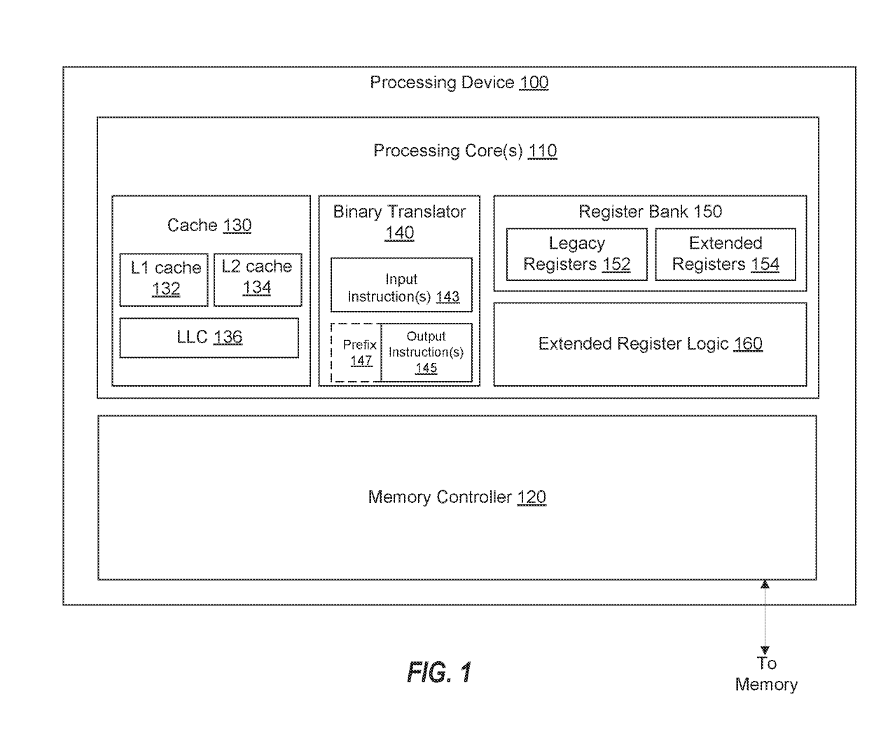

FIG. 1 illustrates a block diagram of a processing device to support binary translation using processor instruction prefixes. The processing device 100 may be generally referred to as “processor” or “CPU”. “Processor” or “CPU” herein shall refer to a device capable of executing instructions encoding arithmetic, logical, or I/O operations. In one illustrative example, a processor may include an arithmetic logic unit (ALU), a control unit, and a plurality of registers. In a further aspect, a processor may include one or more processing cores, and hence may be a single core processor which is typically capable of processing a single instruction pipeline, or a multi-core processor which may simultaneously process multiple instruction pipelines. In another aspect, a processor may be implemented as a single integrated circuit, two or more integrated circuits, or may be a component of a multi-chip module (e.g., in which individual microprocessor dies are included in a single integrated circuit package and hence share a single socket).

As shown in FIG. 1, processing device 100 may include various components. In one embodiment, processing device 100 may include one or more processors cores 110 and a memory controller unit 120, among other components, coupled to each other as shown. The processing device 100 may also include a communication component (not shown) that may be used for point-to-point communication between various components of the processing device 100. The processing device 100 may be used in a computing system (not shown) that includes, but is not limited to, a desktop computer, a tablet computer, a laptop computer, a netbook, a notebook computer, a personal digital assistant (PDA), a server, a workstation, a cellular telephone, a mobile computing device, a smart phone, an Internet appliance or any other type of computing device. In another embodiment, the processing device 100 may be used in a system on a chip (SoC) system. In one embodiment, the SoC may comprise processing device 100 and a memory. The memory for one such system is a DRAM memory. The DRAM memory can be located on the same chip as the processor and other system components. Additionally, other logic blocks such as a memory controller or graphics controller can also be located on the chip.

The processor core(s) 110 may execute instructions for the processing device 100. The instructions may include, but are not limited to, pre-fetch logic to fetch instructions, decode logic to decode the instructions, execution logic to execute instructions and the like. The computing system may be representative of processing systems based on the Pentium® family of processors and/or microprocessors available from Intel® Corporation of Santa Clara, Calif., although other systems (including computing devices having other microprocessors, engineering workstations, set-top boxes and the like) may also be used. In one embodiment, a sample computing system may execute a version of an operating system, embedded software, and/or graphical user interfaces. Thus, embodiments of the disclosure are not limited to any specific combination of hardware circuitry and software.

In an illustrative example, processing core 110 may have a micro-architecture including processor logic and circuits. Processor cores with different micro-architectures can share at least a portion of a common instruction set. For example, similar register architectures may be implemented in different ways in different micro-architectures using various techniques, including dedicated physical registers, one or more dynamically allocated physical registers using a register renaming mechanism (e.g., the use of a register alias table (RAT), a reorder buffer (ROB) and a retirement register file).

Memory controller 120 may perform functions that enable the processing device 100 to access and communicate with memory (not shown) that includes a volatile memory and/or a non-volatile memory. In some embodiments, the memory controller 120 may be located on a processor die associated with processing device 100, while the memory is located off the processor die. In some embodiments, the processing device 100 includes a cache unit 130 to cache instructions and/or data. The cache unit 130 includes, but is not limited to, a level one (L1) 132, level two (L2) 134, and a last level cache (LLC) 136, or any other configuration of the cache memory within the processing device 100. In some embodiments, the L1 cache 132 and L2 cache 134 can transfer data to and from the LLC 136. In one embodiment, the memory controller 120 can be connected to the LLC 136 to transfer data between the cache unit 130 and memory. As shown, the cache unit 130 can be integrated into the processing cores 110. The cache unit 130 may store data (e.g., including instructions) that are utilized by one or more components of the processing device 100.

In some embodiments, the processing device 100 may comprise a binary translator 140. In some embodiment, the binary translator 140 may comprise hardware (e.g., circuitry, dedicated logic, programmable logic, microcode, etc.), software (such as instructions run on a processing device), or a combination thereof. In one embodiment, the binary translator 140 translates or converts input instructions 143 (e.g., legacy instructions) into native code output instructions 145. This may include, but not limited to, “reordering” and “optimizing” an execution of the input instructions 143 by the processing device 100. Reordering a sequence of instructions typically involves changing an order of memory operations, for example, for loading, executing, and/or storing instructions. While optimizing the input instructions 143 may include conditional executing certain instructions based on a particular condition being satisfied.

In operation, the binary translator 140 retrieves the input instructions 143 from the cache unit 130 and then translates those instructions to output instructions 145 used in the new processor architecture. In some embodiments, the binary translator 140 translates/decodes each of the instructions into a corresponding sequence of instructions that direct the processing device 100 to perform certain operations. As noted, embodiments of the present disclosure provide techniques for accessing additional hardware resources of the processing device 100 to support the binary translation of the instructions. In some embodiments, these additional hardware resources may include a register bank 150 comprising a plurality of legacy registers 152 and extended registers 154.

The extended register logic 160 of the processing core 110 may detect that the output instructions 145 include a prefix portion 147. In one embodiment, an x86 compatible opcode may optionally include the prefix 147. The prefix 147 is used to specify one or more registers associated with the processing core 110. For example, the prefix 147 may be employed to specify one or more of the extended registers 154 of the register bank 150 for accessing new processor functionality prescribed by the output instructions 145.

In some embodiments, each instruction may indicate one or more source operands for employment by the processing device 100 during execution of a specified instruction. In one embodiment, the processing device 100 may receive an instruction, for example, from the binary translator 140, which calls a certain operation. In one embodiment, the binary translator 140 receives source input instructions 143 and generates output instructions 145 by inserting prefixes 147 that are later to be interpreted by execution logic of the processing device 100. In some embodiments, the prefix 147 for each of the instructions 145 according to the present disclosure may be used to identify extended registers in the x86 instruction set architecture. At present, the x86 instruction set architecture provides for a default of eight general purpose registers (e.g., legacy registers 152) that are specified in existing x86 instructions according to certain encoding formats. In an x86 embodiment, registers R0-R7 comprise the eight existing legacy registers 152 and the extended registers 154 may comprise a determined number of additional registers R8-Rn (e.g., 64 registers). The extended register logic 160 may control access to these additional registers in accordance with the prefix 147. Various types of structures can be used as registers for the register bank 150 so long as they are capable of storing and providing data as described herein.

As noted above, the register bank 150 comprises the existing architectural registers (e.g., legacy registers 152) and an extended portion of additional registers (e.g., extended registers 154). In some embodiments, registers of the register bank 150 may be exposed to the binary translator 140 of the processing device 100. For example, the instruction prefixes used by the binary translator 140 to specify operands stored in the registers to help translate instructions from a legacy platform to the native platform.

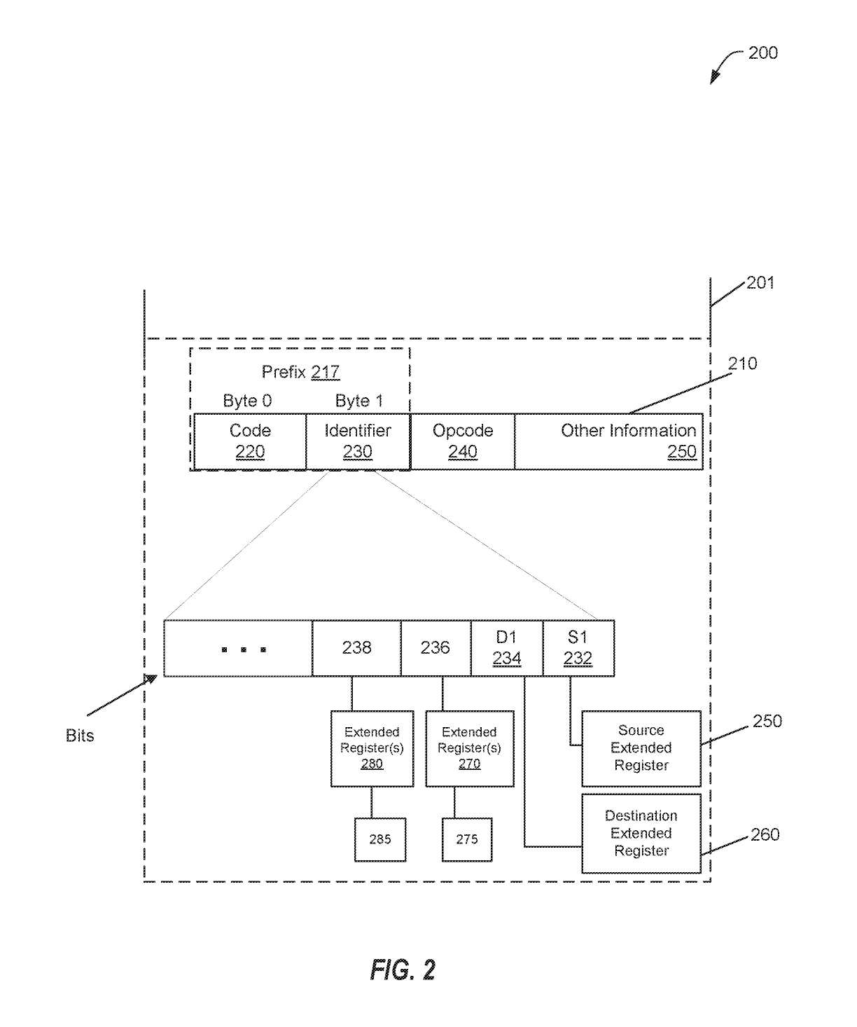

FIG. 2 illustrates a system 200 including a memory 201 for supporting binary translation using processor instruction prefixes according to one embodiment. In this example, the memory 201 includes an instruction 210 (such as one of the output instructions 145), such as one of the instructions 145 associated with processing device 100. The instruction 210 directs the processing device 100 to perform a specific operation prescribed by an opcode 240, such as such as adding two operands together, or moving data to and from a register within the processing core 110. In some embodiments, the instruction 210 may include an opcode prefix 217 comprising a code field 220 and an identifier field 230, as well as other information 240 in the instruction 210 that may include, for example, additional information about an operation for the instruction, such as how the operation is to be performed, address information, etc.

In one embodiment, the code field 220 of the opcode prefix 217 is an indicator of how the remainder of the prefix 217should be interpreted. For example, the code field 220 may include one or more bits to indicate a type of operation to be performed by processing device 100 using one or more registers. In this regard, the identifier field 230 of the opcode prefix 217 may comprise a plurality of bits that identifies the registers (e.g., extended registers 154) that are used in the operation prescribed by the code field 220. In some embodiments, the extended register logic 160 of the processing device 100 accesses the extended registers during execution of the operation indicated by the opcode prefix 217 of the instruction 210.

The opcode prefix 217 of instruction 210 controls access to the new hardware features (e.g., extended registers 154) of the processing device 100 based on the operation prescribed by the instruction 210. In some embodiments, when the instruction 210 is received, for example, from the binary translator 140, the processing device 100 is configured to extract and examine bits of the opcode prefix 217 for addressing the extended registers 154 of the processing device 100. For example, values set in a combination of certain bits of the identifier field 230 of the prefix 217 may be used to identify one or more extended registers 154 associated with the processing device 100. In some embodiments, the extended register logic 160 of the processing device 100 examines the opcode prefix 217 in view of the capabilities of the processing device 100 to determine whether the opcode prefix 217 is valid for use with the processing device 100. For example, the extended register logic 160 may compare an optimized instruction fetch address with a predefined range. If it is determined that the opcode prefix 217 is not valid based on the comparison, then an alert may be generated or the invalid prefix may be simply ignored. If the identifiers match, then the extended register logic 160 may determine that the processing device 100 is the type of new processor that includes the extended registers 154 addressed by the identifier field 230 of the opcode prefix 217.

In some embodiments, the identifier field 230 may include a certain number of bits, such as eight, for addressing the additional registers in the processing device 100. In one embodiment, the identifier field 230 may identify a source address extension field (S1) 232 and a destination address extension field (D1) 234. The S1 field 234 comprises certain bits of the identifier field 230 and is employed by the extended register logic 160 of the processing device 100 to identify a source extended register 250 that may be used when binary translator 140 decides to preserve source registers values and/or needs to access non-default GPR bank for other reasons. The D1 field 234 also comprises certain bits of the identifier field 230 and is employed by the extended register logic 160 of the processing device 100 to identify a destination extended register 260 of the register bank 150.

In one illustrative embodiment, binary translator 140 may decide to translate some instruction into a non-destructive operation, in order to preserve values in a source register, which would then be used by a subsequent instruction. For example, an original code may repeatedly load a value from memory into a register, do a computation, and then reload that same value to do further computations. The re-loading of the value is redundant, and having a non-destructive operation would enable the computation to be done without having to repeatedly re-load the value from memory.

To preserve information in a source register from being changed during an operation, the identifier field 230 of the prefix 217 may identify a source extended register 250 and the destination register 260 as described above. In this example, the source extended register 250 and destination register 260 represent different registers in the register bank 150. The instruction 210 may direct the processing device 100 to add a specified value to contents of the source extended register 250. In this example, the processing device 100 may perform a specified operation (e.g., an arithmetic operation) using contents from the source extended register 250 and store the results in the destination register address 260. Thus, the contents of the source extended register 250 are preserved.

In another illustrative embodiment, the prefix code 220 of the prefix 217 of instruction 210 may prescribe a conditional operation for determining a condition upon which the instruction 210 is to be executed. For example, the conditional operation may include using the extended registers to indicate branching between two different operations associated with instructions being translated by the binary translator 140. In some embodiments, the processing device 100 may conditionally execute an operation associated with instruction 210 based on the prefix 217. In one embodiment, a certain combination of bits of the code field 220 of prefix 217 may represent different conditions. In some embodiments, the processing device 100 performs a lookup operation in a mapping table 275 that maps certain prefixes to certain conditions. The mapping table 275 may be implemented in hardware, firmware, software, or a combination thereof.

Based on the condition matching an entry in the mapping table 275, the processing device 100 is configured to conditionally execute one or more operations associated with the instruction 210. For example, memory addresses referenced by the operations may be stored in the extended registers 270 identified by certain bits 236 of the prefix 230. In one example, the extended register logic 160 may compare two values stored in different extended registers 270. Then, based on a condition specified by the prefix code 220, the processing device 100 may jump over/bypass or execute of a particular operation associated with the instruction 210.

In yet another illustrative embodiment, the prefix code 220 may prescribe an extended operation for tracking the reordering of memory loads and memory stores associated with a sequence of instructions. An optimizing processes associated with the binary translator 140 can optimize for execution an original instruction sequence into a reordered instruction sequence prior to storage in memory and subsequent access by the processing device 100. In some embodiments, a memory address accessed by each one of the reordered instructions may be stored in one or more extended registers 280 prescribed by the identifier filed 230 of the prefix 217. In some embodiments, the memory address is pushed in an “alias” hardware 285 (e.g., a table) that is used to perform checking on loads and stores. At runtime time, the processing device 100 may perform a check by comparing values in the extended registers 280 to addresses in the hardware 285 to determine whether the instructions have been correctly reordered, such as when a load and store of the instructions will access the same memory location (known as “memory aliasing”). The processing device 100 preforms the check against the alias hardware 285 in response to determining that the instruction 210 has been reordered based on the prefix 217.

To validate the reordering of the instruction 210, the processing device 100 may identify one or more extended registers using the identifier 230 of prefix 217. In some embodiments, a memory address accessed by the instruction may be stored in at least one of the registers in a location corresponding to the instruction's location in the original execution order of a sequence of instructions. The processing device 100 may then compare that memory address stored in the register with a memory address accessed by instruction 210. Based on the comparison, the processing device 100 may determine that the instruction 210 should not have been reordered or has been reordered incorrectly. For example, the processing device 100 may determine that the two memory addresses use the same memory location, which indicates that the reordering is invalid due to memory aliasing. In some embodiment, if the reordering is invalid, a fault to a software process may be generated for resolution, for example, by rolling back an operation associated with the instruction 210. For example, when memory aliasing occurs and operations have been re-ordered, this will raise a re-ordering fault that requires a roll-back of the instructions. Otherwise, the proceeding device 100 may continue processing the reordered instructions as prescribed by the prefix 217.

Still further, the prefix 217 of instruction 210 may be used to control other kinds of new hardware features associated with the processing device 100 as prescribed by the code 220 and identifier 230 of the prefix.

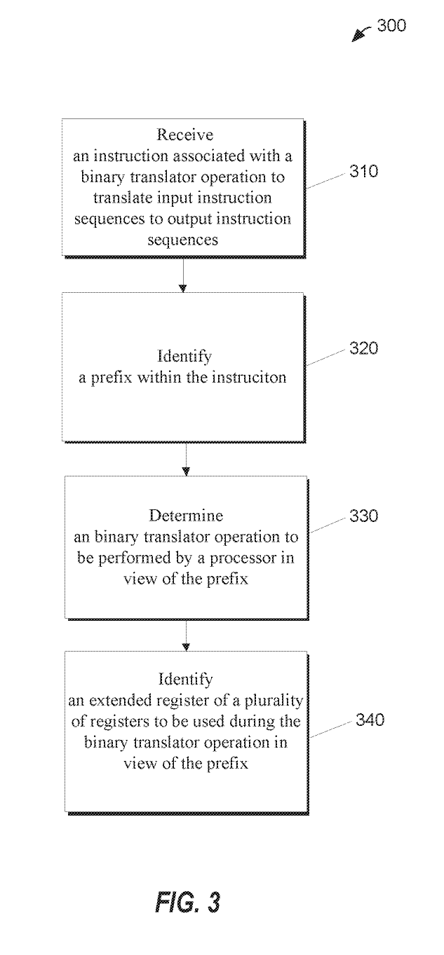

FIG. 3 illustrates a flow diagram of a method for binary translation support using processor instruction prefixes according to one embodiment. Method 300 may be performed by processing logic that may comprise hardware (e.g., circuitry, dedicated logic, programmable logic, microcode, etc.), software (such as instructions run on a processing device), firmware, or a combination thereof. In one embodiment, the processing device 100 in FIG. 1 as direct by the extended register logic 160 may perform method 300. Although shown in a particular sequence or order, unless otherwise specified, the order of the processes can be modified. Thus, the illustrated implementations should be understood only as examples, and the illustrated processes can be performed in a different order, and some processes may be performed in parallel. Additionally, one or more processes can be omitted in various embodiments. Thus, not all processes are required in every implementation. Other process flows are possible.

Method 300 begins at block 310 where an instruction associated with a binary translator operation to translate input instruction sequences to output instruction sequences is received. In block 320, a prefix within the instruction. In block 330, a binary translator operation to be performed by a processor is determined in view of the prefix. An extended register of a plurality of registers to be used during the binary translator operation is identified in view of the prefix in block 340.

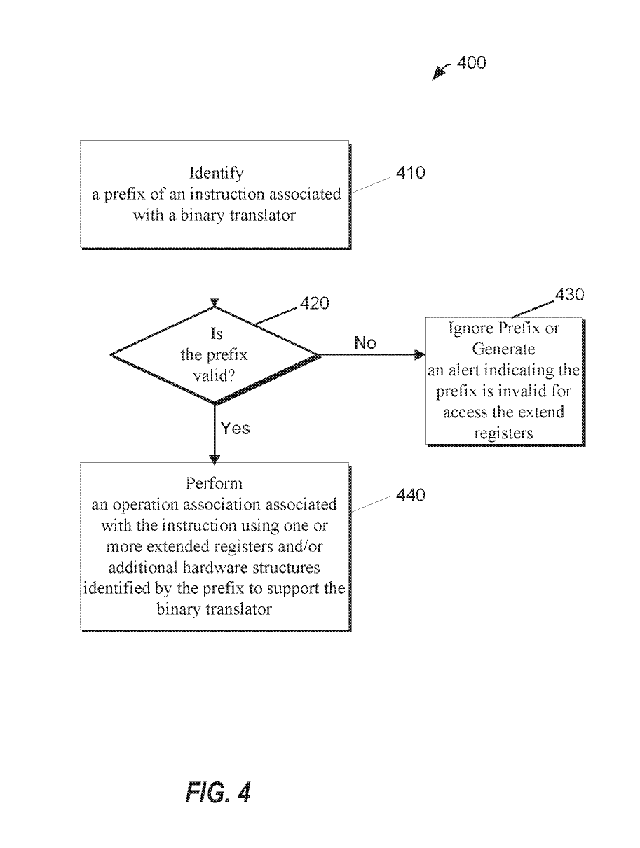

FIG. 4 illustrates a flow diagram of a method for extending general purpose registers using processor instruction prefixes according to one embodiment. Method 400 may be performed by processing logic that may comprise hardware (e.g., circuitry, dedicated logic, programmable logic, microcode, etc.), software (such as instructions run on a processing device), firmware, or a combination thereof. In one embodiment, the processing device 100 in FIG. 1 as direct by the extended register logic 160 may perform method 400. Although shown in a particular sequence or order, unless otherwise specified, the order of the processes can be modified. Thus, the illustrated implementations should be understood only as examples, and the illustrated processes can be performed in a different order, and some processes may be performed in parallel. Additionally, one or more processes can be omitted in various embodiments. Thus, not all processes are required in every implementation. Other process flows are possible.

Method 400 begins at block 410 where a prefix of an instruction associated with a binary translator is identified. Block 420 branches depending on whether the prefix is valid in that it can be executed by a processor associated with the binary translator. If it is determined that the prefix is invalid, method 400 may proceed to block 430 where the prefix may be ignored or an alert is generated indicating the prefix is invalid of accessing the extended registers. Otherwise, method 400 may proceed to block 440. In block 440, an operation associated with the instruction may be performed by the processor using one or more extended registers and/or additional hardware identified by the prefix to support the binary translator.

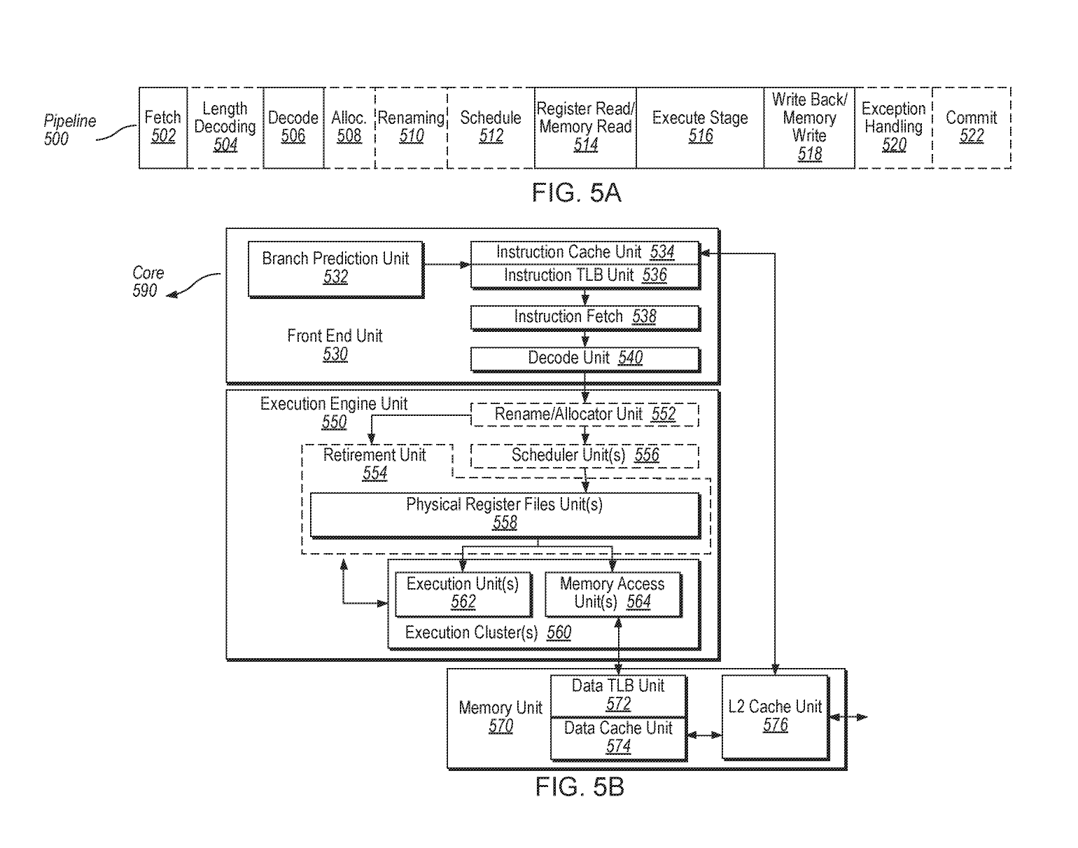

FIG. 5A is a block diagram illustrating a micro-architecture for a processor 500 that implements techniques for binary translation support using processor instruction prefixes in accordance with one embodiment of the disclosure. Specifically, processor 500 depicts an in-order architecture core and a register renaming logic, out-of-order issue/execution logic to be included in a processor according to at least one embodiment of the disclosure.

Processor 500 includes a front end unit 530 coupled to an execution engine unit 550, and both are coupled to a memory unit 570. The processor 500 may include a reduced instruction set computing (RISC) core, a complex instruction set computing (CISC) core, a very long instruction word (VLIW) core, or a hybrid or alternative core type. As yet another option, processor 500 may include a special-purpose core, such as, for example, a network or communication core, compression engine, graphics core, or the like. In one embodiment, processor 500 may be a multi-core processor or may part of a multi-processor system.

The front end unit 530 includes a branch prediction unit 532 coupled to an instruction cache unit 534, which is coupled to an instruction translation lookaside buffer (TLB) 536, which is coupled to an instruction fetch unit 538, which is coupled to a decode unit 540. The decode unit 540 (also known as a decoder) may decode instructions, and generate as an output one or more micro-operations, micro-code entry points, microinstructions, other instructions, or other control signals, which are decoded from, or which otherwise reflect, or are derived from, the original instructions. The decoder 540 may be implemented using various different mechanisms. Examples of suitable mechanisms include, but are not limited to, look-up tables, hardware implementations, programmable logic arrays (PLAs), microcode read only memories (ROMs), etc. The instruction cache unit 534 is further coupled to the memory unit 570. The decode unit 540 is coupled to a rename/allocator unit 552 in the execution engine unit 550.

The execution engine unit 550 includes the rename/allocator unit 552 coupled to a retirement unit 554 and a set of one or more scheduler unit(s) 556. The scheduler unit(s) 556 represents any number of different schedulers, including reservations stations (RS), central instruction window, etc. The scheduler unit(s) 556 is coupled to the physical register file(s) unit(s) 558. Each of the physical register file(s) units 558 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 558 is overlapped by the retirement unit 554 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.). The execution engine unit 550 may include for example a power management unit (PMU) 590 that governs power functions of the functional units.

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 554 and the physical register file(s) unit(s) 558 are coupled to the execution cluster(s) 560. The execution cluster(s) 560 includes a set of one or more execution units 562 and a set of one or more memory access units 564. The execution units 562 may perform various operations (e.g., shifts, addition, subtraction, multiplication) and operate on various types of data (e.g., scalar floating point, packed integer, packed floating point, vector integer, vector floating point).

While some embodiments may include a number of execution units dedicated to specific functions or sets of functions, other embodiments may include only one execution unit or multiple execution units that all perform all functions. The scheduler unit(s) 556, physical register file(s) unit(s) 558, and execution cluster(s) 560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 564). It should also be understood that where separate pipelines are used, one or more of these pipelines may be out-of-order issue/execution and the rest in-order.

The set of memory access units 564 is coupled to the memory unit 570, which may include a data prefetcher 580, a data TLB unit 572, a data cache unit (DCU) 574, and a level 2 (L2) cache unit 576, to name a few examples. In some embodiments DCU 574 is also known as a first level data cache (L1 cache). The DCU 574 may handle multiple outstanding cache misses and continue to service incoming stores and loads. It also supports maintaining cache coherency. The data TLB unit 572 is a cache used to improve virtual address translation speed by mapping virtual and physical address spaces. In one exemplary embodiment, the memory access units 564 may include a load unit, a store address unit, and a store data unit, each of which is coupled to the data TLB unit 572 in the memory unit 570. The L2 cache unit 576 may be coupled to one or more other levels of cache and eventually to a main memory.

In one embodiment, the data prefetcher 580 speculatively loads/prefetches data to the DCU 574 by automatically predicting which data a program is about to consume. Prefeteching may refer to transferring data stored in one memory location of a memory hierarchy (e.g., lower level caches or memory) to a higher-level memory location that is closer (e.g., yields lower access latency) to the processor before the data is actually demanded by the processor. More specifically, prefetching may refer to the early retrieval of data from one of the lower level caches/memory to a data cache and/or prefetch buffer before the processor issues a demand for the specific data being returned.

In one implementation, processor 500 may be the same as processing device 100 described with respect to FIG. 1. In particular, the data TLB unit 572 may be the same as TLB 155 and described with respect to FIG. 1, to implement techniques for binary translation support using processor instruction prefixes in a processing device described with respect to implementations of the disclosure.

The processor 500 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes a separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 5B is a block diagram illustrating an in-order pipeline and a register renaming stage, out-of-order issue/execution pipeline implemented by processor 500 of FIG. 5A according to some embodiments of the disclosure. The solid lined boxes in FIG. 5B illustrate an in-order pipeline, while the dashed lined boxes illustrates a register renaming, out-of-order issue/execution pipeline. In FIG. 5B, a processor pipeline 501 includes a fetch stage 502, a length decode stage 504, a decode stage 506, an allocation stage 508, a renaming stage 510, a scheduling (also known as a dispatch or issue) stage 512, a register read/memory read stage 514, an execute stage 516, a write back/memory write stage 518, an exception handling stage 522, and a commit stage 524. In some embodiments, the ordering of stages 502-524 may be different than illustrated and are not limited to the specific ordering shown in FIG. 5B.

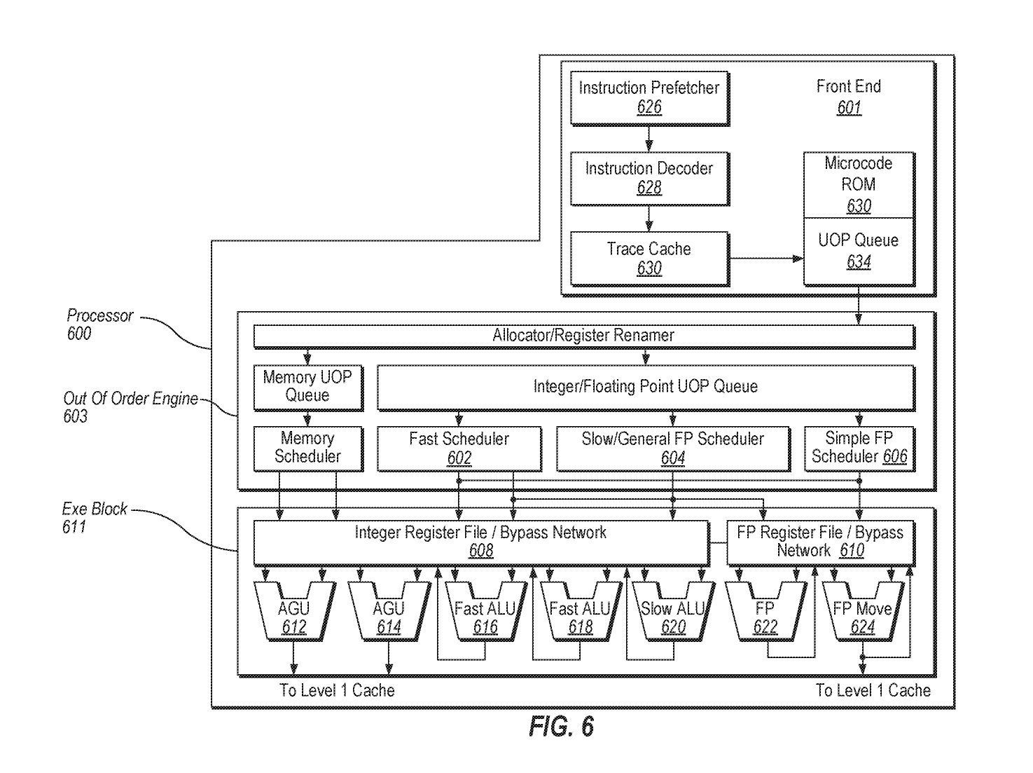

FIG. 6 illustrates a block diagram of the micro-architecture for a processor 600 that includes logic circuits to implement techniques for binary translation support using processor instruction prefixes in accordance with one embodiment of the disclosure. In some embodiments, an instruction in accordance with one embodiment can be implemented to operate on data elements having sizes of byte, word, doubleword, quadword, etc., as well as datatypes, such as single and double precision integer and floating point datatypes. In one embodiment the in-order front end 601 is the part of the processor 600 that fetches instructions to be executed and prepares them to be used later in the processor pipeline.

The front end 601 may include several units. In one embodiment, the instruction prefetcher 626 fetches instructions from memory and feeds them to an instruction decoder 628 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 630 takes decoded uops and assembles them into program ordered sequences or traces in the uop queue 634 for execution. When the trace cache 630 encounters a complex instruction, the microcode ROM 632 provides the uops needed to complete the operation.

Some instructions are converted into a single micro-op, whereas others need several micro-ops to complete the full operation. In one embodiment, if more than four micro-ops are needed to complete an instruction, the decoder 628 accesses the microcode ROM 632 to do the instruction. For one embodiment, an instruction can be decoded into a small number of micro ops for processing at the instruction decoder 628. In another embodiment, an instruction can be stored within the microcode ROM 632 should a number of micro-ops be needed to accomplish the operation. The trace cache 630 refers to an entry point programmable logic array (PLA) to determine a correct micro-instruction pointer for reading the micro-code sequences to complete one or more instructions in accordance with one embodiment from the micro-code ROM 632. After the microcode ROM 632 finishes sequencing micro-ops for an instruction, the front end 601 of the machine resumes fetching micro-ops from the trace cache 630.

The out-of-order execution engine 603 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 602, slow/general floating point scheduler 604, and simple floating point scheduler 606. The uop schedulers 602, 604, 606, determine when a uop is ready to execute based on the readiness of their dependent input register operand sources and the availability of the execution resources the uops need to complete their operation. The fast scheduler 602 of one embodiment can schedule on each half of the main clock cycle while the other schedulers can only schedule once per main processor clock cycle. The schedulers arbitrate for the dispatch ports to schedule uops for execution.

Register files 608, 610, sit between the schedulers 602, 604, 606, and the execution units 612, 614, 616, 618, 620, 622, 624 in the execution block 611. There is a separate register file 608, 610, for integer and floating point operations, respectively. Each register file 608, 610, of one embodiment also includes a bypass network that can bypass or forward just completed results that have not yet been written into the register file to new dependent uops. The integer register file 608 and the floating point register file 610 are also capable of communicating data with the other. For one embodiment, the integer register file 608 is split into two separate register files, one register file for the low order 32 bits of data and a second register file for the high order 32 bits of data. The floating point register file 610 of one embodiment has 128 bit wide entries because floating point instructions typically have operands from 64 to 128 bits in width.

The execution block 611 contains the execution units 612, 614, 616, 618, 620, 622, 624, where the instructions are actually executed. This section includes the register files 608, 610, that store the integer and floating point data operand values that the micro-instructions need to execute. The processor 600 of one embodiment is comprised of a number of execution units: address generation unit (AGU) 612, AGU 614, fast ALU 616, fast ALU 618, slow ALU 620, floating point ALU 622, floating point move unit 624. For one embodiment, the floating point execution blocks 622, 624, execute floating point, MMX, SIMD, and SSE, or other operations. The floating point ALU 622 of one embodiment includes a 64 bit by 64 bit floating point divider to execute divide, square root, and remainder micro-ops. For embodiments of the disclosure, instructions involving a floating point value may be handled with the floating point hardware.

In one embodiment, the ALU operations go to the high-speed ALU execution units 616, 618. The fast ALUs 616, 618, of one embodiment can execute fast operations with an effective latency of half a clock cycle. For one embodiment, most complex integer operations go to the slow ALU 620 as the slow ALU 620 includes integer execution hardware for long latency type of operations, such as a multiplier, shifts, flag logic, and branch processing. Memory load/store operations are executed by the AGUs 612, 614. For one embodiment, the integer ALUs 616, 618, 620, are described in the context of performing integer operations on 64 bit data operands. In alternative embodiments, the ALUs 616, 618, 620, can be implemented to support a variety of data bits including 16, 32, 128, 256, etc. Similarly, the floating point units 622, 624, can be implemented to support a range of operands having bits of various widths. For one embodiment, the floating point units 622, 624, can operate on 128 bits wide packed data operands in conjunction with SIMD and multimedia instructions.

In one embodiment, the uops schedulers 602, 604, 606, dispatch dependent operations before the parent load has finished executing. As uops are speculatively scheduled and executed in processor 600, the processor 600 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The processor 600 also includes logic to implement store address prediction for memory disambiguation according to embodiments of the disclosure. In one embodiment, the execution block 611 of processor 600 may include a store address predictor (not shown) for implementing techniques for binary translation support using processor instruction prefixes.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIMD registers for packed data.

For the discussions below, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

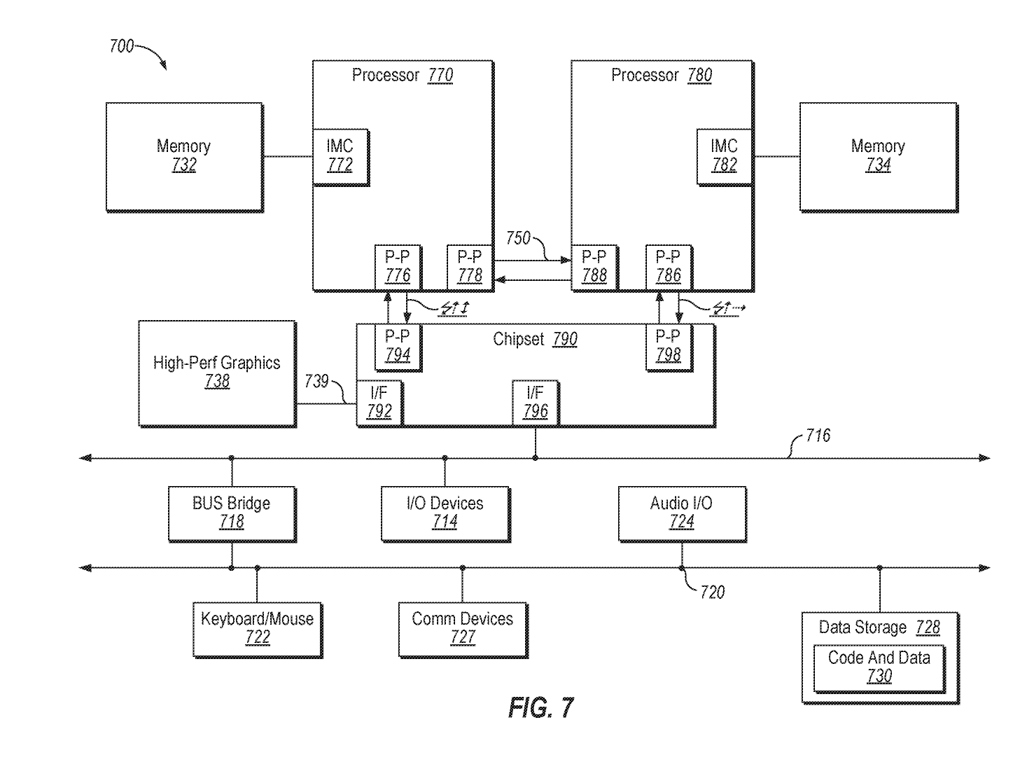

Embodiments may be implemented in many different system types. Referring now to FIG. 7, shown is a block diagram illustrating a system 700 in which an embodiment of the disclosure may be used. As shown in FIG. 7, multiprocessor system 700 is a point-to-point interconnect system, and includes a first processor 770 and a second processor 780 coupled via a point-to-point interconnect 750. While shown with only two processors 770, 780, it is to be understood that the scope of embodiments of the disclosure is not so limited. In other embodiments, one or more additional processors may be present in a given processor. In one embodiment, the multiprocessor system 700 may implement techniques for binary translation support using processor instruction prefixes as described herein.

Processors 770 and 780 are shown including integrated memory controller units 772 and 782, respectively. Processor 770 also includes as part of its bus controller units point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may exchange information with a chipset 790 via individual P-P interfaces 752, 754 using point to point interface circuits 776, 794, 786, 798. Chipset 790 may also exchange information with a high-performance graphics circuit 738 via a high-performance graphics interface 739.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the disclosure is not so limited.

As shown in FIG. 7, various I/O devices 714 may be coupled to first bus 716, along with a bus bridge 718 which couples first bus 716 to a second bus 720. In one embodiment, second bus 720 may be a low pin count (LPC) bus. Various devices may be coupled to second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to second bus 720. Note that other architectures are possible. For example, instead of the point-to-point architecture of FIG. 7, a system may implement a multi-drop bus or other such architecture.

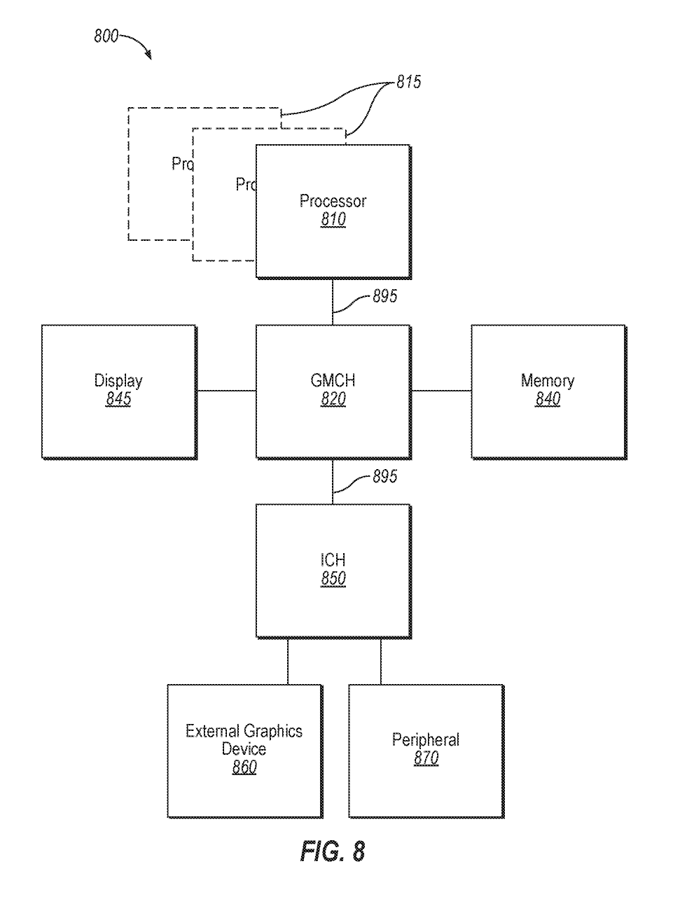

Referring now to FIG. 8, shown is a block diagram of a system 800 in which one embodiment of the disclosure may operate. The system 800 may include one or more processors 810, 815, which are coupled to graphics memory controller hub (GMCH) 820. The optional nature of additional processors 815 is denoted in FIG. 8 with broken lines. In one embodiment, processors 810, 815 implement techniques for binary translation support using processor instruction prefixes according to embodiments of the disclosure.

Each processor 810, 815 may be some version of the circuit, integrated circuit, processor, and/or silicon integrated circuit as described above. However, it should be noted that it is unlikely that integrated graphics logic and integrated memory control units would exist in the processors 810, 815. FIG. 8 illustrates that the GMCH 820 may be coupled to a memory 840 that may be, for example, a dynamic random access memory (DRAM). The DRAM may, for at least one embodiment, be associated with a non-volatile cache.

The GMCH 820 may be a chipset, or a portion of a chipset. The GMCH 820 may communicate with the processor(s) 810, 815 and control interaction between the processor(s) 810, 815 and memory 840. The GMCH 820 may also act as an accelerated bus interface between the processor(s) 810, 815 and other elements of the system 800. For at least one embodiment, the GMCH 820 communicates with the processor(s) 810, 815 via a multi-drop bus, such as a frontside bus (FSB) 895.

Furthermore, GMCH 820 is coupled to a display 845 (such as a flat panel or touchscreen display). GMCH 820 may include an integrated graphics accelerator. GMCH 820 is further coupled to an input/output (I/O) controller hub (ICH) 850, which may be used to couple various peripheral devices to system 800. Shown for example in the embodiment of FIG. 8 is an external graphics device 860, which may be a discrete graphics device, coupled to ICH 850, along with another peripheral device 870.

Alternatively, additional or different processors may also be present in the system 800. For example, additional processor(s) 815 may include additional processors(s) that are the same as processor 810, additional processor(s) that are heterogeneous or asymmetric to processor 810, accelerators (such as, e.g., graphics accelerators or digital signal processing (DSP) units), field programmable gate arrays, or any other processor. There can be a variety of differences between the processor(s) 810, 815 in terms of a spectrum of metrics of merit including architectural, micro-architectural, thermal, power consumption characteristics, and the like. These differences may effectively manifest themselves as asymmetry and heterogeneity amongst the processors 810, 815. For at least one embodiment, the various processors 810, 815 may reside in the same die package.

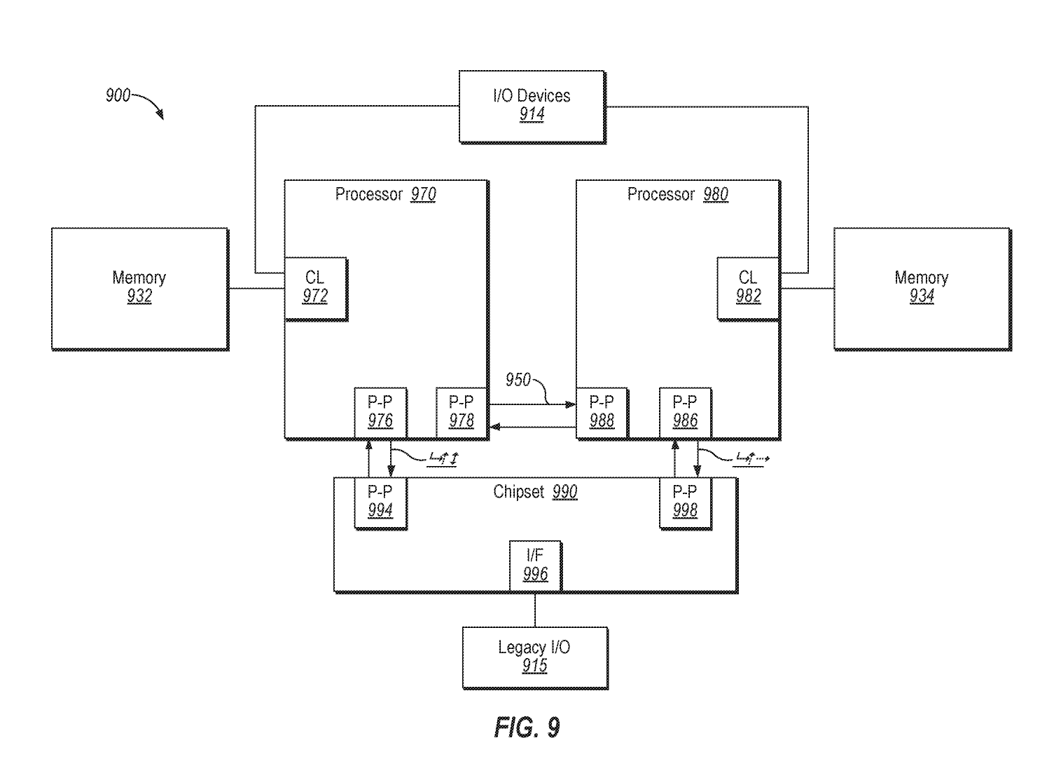

Referring now to FIG. 9, shown is a block diagram of a system 900 in which an embodiment of the disclosure may operate. FIG. 9 illustrates processors 970, 980. In one embodiment, processors 970, 980 may implement techniques for binary translation support using processor instruction prefixes as described above. Processors 970, 980 may include integrated memory and I/O control logic (“CL”) 972 and 982, respectively and intercommunicate with each other via point-to-point interconnect 950 between point-to-point (P-P) interfaces 978 and 988 respectively. Processors 970, 980 each communicate with chipset 990 via point-to-point interconnects 952 and 954 through the respective P-P interfaces 976 to 994 and 986 to 998 as shown. For at least one embodiment, the CL 972, 982 may include integrated memory controller units. CLs 972, 982 may include I/O control logic. As depicted, memories 932, 934 coupled to CLs 972, 982 and I/O devices 914 are also coupled to the control logic 972, 982. Legacy I/O devices 915 are coupled to the chipset 990 via interface 996.

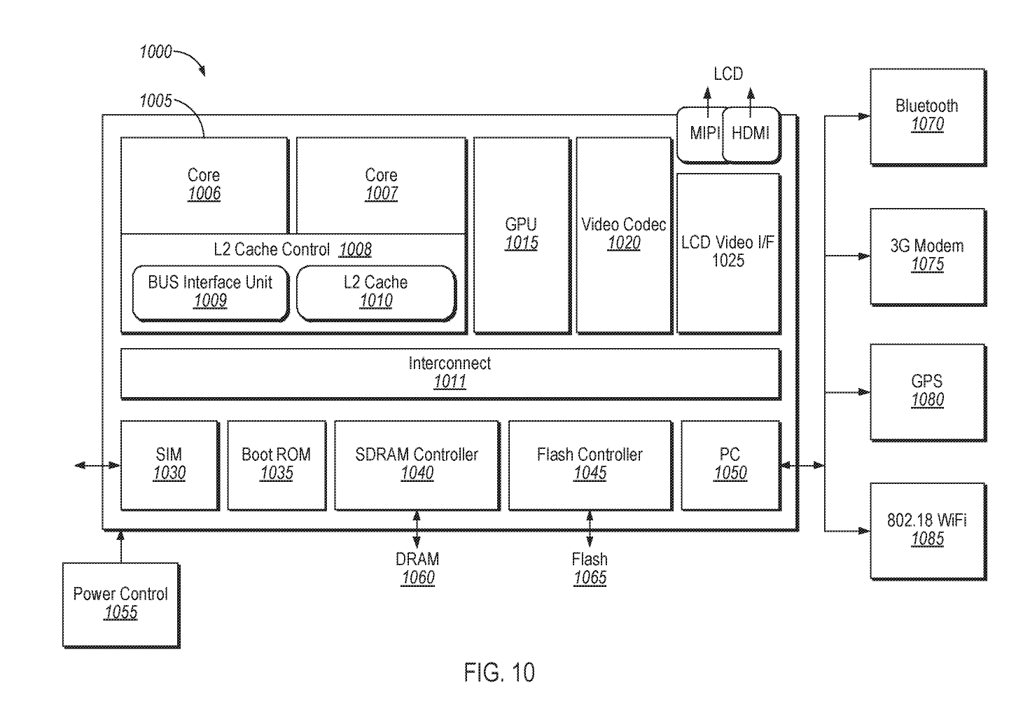

Embodiments may be implemented in many different system types. FIG. 10 is a block diagram of a SoC 1000 in accordance with an embodiment of the disclosure. Dashed lined boxes are optional features on more advanced SoCs. In FIG. 10, an interconnect unit(s) 1012 is coupled to: an application processor 1020 which includes a set of one or more cores 1002A-N and shared cache unit(s) 1006; a system agent unit 1010; a bus controller unit(s) 1016; an integrated memory controller unit(s) 1014; a set or one or more media processors 1018 which may include integrated graphics logic 1008, an image processor 1024 for providing still and/or video camera functionality, an audio processor 1026 for providing hardware audio acceleration, and a video processor 1028 for providing video encode/decode acceleration; an static random access memory (SRAM) unit 1030; a direct memory access (DMA) unit 1032; and a display unit 1040 for coupling to one or more external displays. In one embodiment, a memory module may be included in the integrated memory controller unit(s) 1014. In another embodiment, the memory module may be included in one or more other components of the SoC 1000 that may be used to access and/or control a memory. The application processor 1020 may include a PMU for implementing silent memory instructions and miss-rate tracking to optimize switching policy on threads as described in embodiments herein.

The memory hierarchy includes one or more levels of cache within the cores, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof.

In some embodiments, one or more of the cores 1002A-N are capable of multi-threading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture and/or instruction set. For example, some of the cores 1002A-N may be in order while others are out-of-order. As another example, two or more of the cores 1002A-N may be capable of execution the same instruction set, while others may be capable of executing only a subset of that instruction set or a different instruction set.

The application processor 1020 may be a general-purpose processor, such as a Core™ i3, i5, i7, 2 Duo and Quad, Xeon™, Itanium™, Atom™ or Quark™ processor, which are available from Intel™ Corporation, of Santa Clara, Calif. Alternatively, the application processor 1020 may be from another company, such as ARM Holdings™, Ltd, MIPS™, etc. The application processor 1020 may be a special-purpose processor, such as, for example, a network or communication processor, compression engine, graphics processor, co-processor, embedded processor, or the like. The application processor 1020 may be implemented on one or more chips. The application processor 1020 may be a part of and/or may be implemented on one or more substrates using any of a number of process technologies, such as, for example, BiCMOS, CMOS, or NMOS.

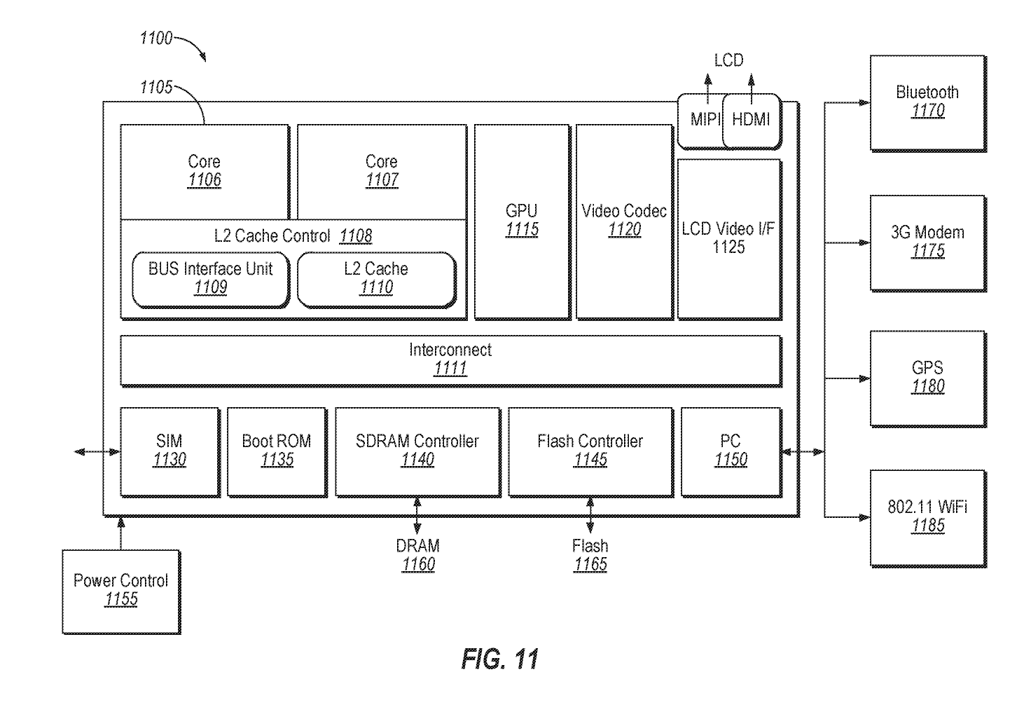

FIG. 11 is a block diagram of an embodiment of a system on-chip (SoC) design in accordance with the disclosure. As a specific illustrative example, SoC 1100 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1100 includes 2 cores—1106 and 1107. Cores 1106 and 1107 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1106 and 1107 are coupled to cache control 1108 that is associated with bus interface unit 1109 and L2 cache 1110 to communicate with other parts of system 1100. Interconnect 1110 includes an on-chip interconnect, such as an IOSF, AMBA, or other interconnect discussed above, which potentially implements one or more aspects of the described disclosure. In one embodiment, cores 1106, 1107 may implement techniques for binary translation support using processor instruction prefixes as described in embodiments herein.

Interconnect 1110 provides communication channels to the other components, such as a Subscriber Identity Module (SIM) 1130 to interface with a SIM card, a boot ROM 1140 to hold boot code for execution by cores 1106 and 1107 to initialize and boot SoC 1100, a SDRAM controller 1140 to interface with external memory (e.g. DRAM 1160), a flash controller 1145 to interface with non-volatile memory (e.g. Flash 1165), a peripheral control 1150 (e.g. Serial Peripheral Interface) to interface with peripherals, video codecs 1120 and Video interface 1125 to display and receive input (e.g. touch enabled input), GPU 1115 to perform graphics related computations, etc. Any of these interfaces may incorporate aspects of the disclosure described herein. In addition, the system 1100 illustrates peripherals for communication, such as a Bluetooth module 1170, 3G modem 1175, GPS 1180, and Wi-Fi 1185.

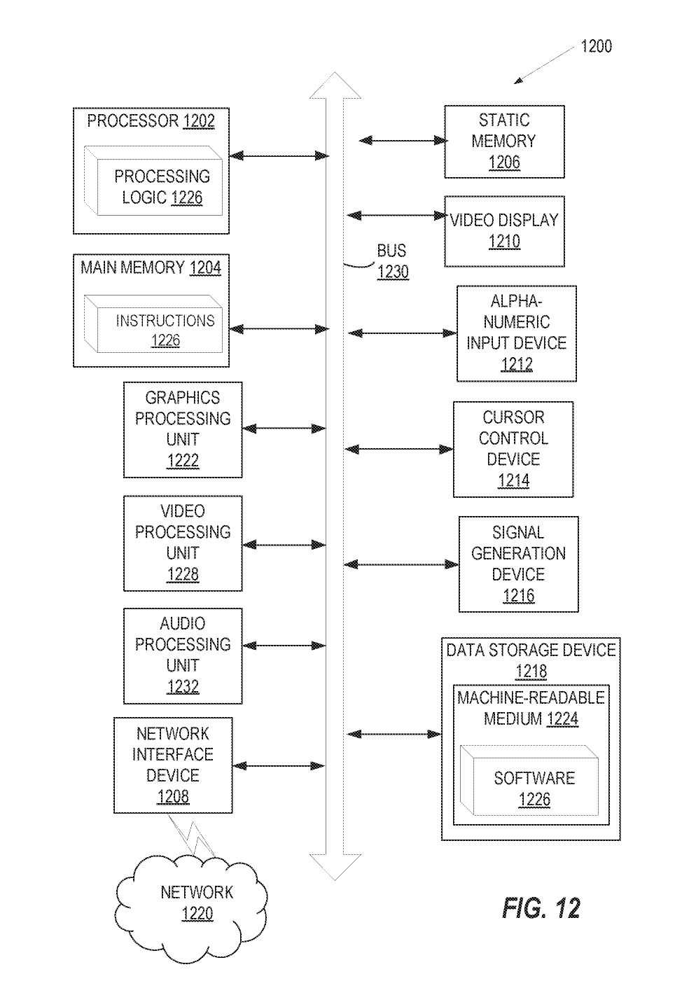

FIG. 12 illustrates a diagrammatic representation of a machine in the example form of a computer system 1200 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1200 includes a processing device 1202, a main memory 1204 (e.g., read-only memory (ROM), flash memory, dynamic random access memory (DRAM) (such as synchronous DRAM (SDRAM) or DRAM (RDRAM), etc.), a static memory 1206 (e.g., flash memory, static random access memory (SRAM), etc.), and a data storage device 1218, which communicate with each other via a bus 1230.

Processing device 1202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. In one embodiment, processing device 1202 may include one or processing cores. The processing device 1202 is configured to execute the processing logic 1226 for performing the operations and steps discussed herein. In one embodiment, processing device 1202 is the same as processor architecture 100 described with respect to FIG. 1 that implements techniques for binary translation support using processor instruction prefixes as described herein with embodiments of the disclosure.

The computer system 1200 may further include a network interface device 1208 communicably coupled to a network 1220. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), and a signal generation device 1216 (e.g., a speaker). Furthermore, computer system 1200 may include a graphics processing unit 1222, a video processing unit 1228, and an audio processing unit 1232.

The data storage device 1218 may include a machine-accessible storage medium 1224 on which is stored software 1226 implementing any one or more of the methodologies of functions described herein, such as implementing silent memory instructions and miss-rate tracking to optimize switching policy on threads in a processing device as described above. The software 1226 may also reside, completely or at least partially, within the main memory 1204 as instructions 1226 and/or within the processing device 1202 as processing logic 1226 during execution thereof by the computer system 1200; the main memory 1204 and the processing device 1202 also constituting machine-accessible storage media.

The machine-readable storage medium 1224 may also be used to store instructions 1226 implementing silent memory instructions and miss-rate tracking to optimize switching policy on threads in a processing device such as described with respect to processing device 100 in FIG. 1, and/or a software library containing methods that call the above applications. While the machine-accessible storage medium 1128 is shown in an example embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the disclosure. The term “machine-accessible storage medium” shall accordingly be taken to include, but not be limited to, solid-state memories, and optical and magnetic media.

The following examples pertain to further embodiments.

Example 1 is a processing system comprising: 1) a register bank having a plurality of registers to store data for use in executing instructions; and 2) a processor core, operatively coupled to the register bank, to: a) receive an instruction to be executed by the processor core, wherein the instruction is associated with a binary translator operation to translate input instruction sequences to output instruction sequences; and b) identify, within the instruction, an opcode prefix referencing an extended register of the plurality of registers to be used during the binary translator operation, wherein the extended register preserves a source register value of the plurality of registers.

In Example 2, the subject matter of Example 1, wherein the processor core further to determine whether the opcode prefix associated with the binary translator operation is valid in view of a capability of the processing system.

In Example 3, the subject matter of Examples 1-2, wherein the processor core further to, responsive to determining that the opcode prefix is invalid, generate an alert indicating that the binary translator operation cannot be performed by the processing system.

In Example 4, the subject matter of Examples 1-3, wherein the processor core further to: a) identify a first register of the plurality of registers in view the opcode prefix; and b) perform the binary translator operation using data stored in the first register.

In Example 5, the subject matter of Examples 1-4, wherein the first register comprises an address associated with an execution of the instruction.

In Example 6, the subject matter of Examples 1-5, wherein the binary translator operation comprises an arithmetic operation using a value stored in the first register.

In Example 7, the subject matter of Examples 1-6, wherein results of the arithmetic operation are stored in the extended register.

In Example 8, the subject matter of Examples 1-7, wherein the first register and the extended register identify different registers located in the plurality of registers.

Various embodiments may have different combinations of the structural features described above. For instance, all optional features of the processor described above may also be implemented with respect to a method or process described herein and specifics in the examples may be used anywhere in one or more embodiments.

Example 9 is a method, comprising: a) receiving, by a processor, an instruction to be executed by the processor, the instruction is associated with a binary translator operation to translate input instruction sequences to output instruction sequences; and b) identifying, within the instruction, an opcode prefix referencing an extended register of a plurality of registers to be used during the binary translator operation, wherein the extended register preserves a source register value of the plurality of registers.

In Example 10, the subject matter of Example 9, further comprising determining whether the opcode prefix associated with the binary translator operation is valid in view of a capability of the processor.

In Example 11, the subject matter of Examples 9-10, further comprising determining responsive to determining that the opcode prefix is invalid, generating an alert indicating that the binary translator operation cannot be performed by the processor.

In Example 12, the subject matter of Examples 9-11, wherein further comprising: a) identifying a first register of the plurality of registers in view the opcode prefix; and b) performing the binary translator operation using data stored in the first register.

In Example 13, the subject matter of Examples 9-12, wherein the first register comprises an address associated with an execution of the instruction.

In Example 14, the subject matter of Examples 9-13, the binary translator operation comprises an arithmetic operation using a value stored in the first register.

In Example 15, the subject matter of Examples 9-14, wherein results of the arithmetic operation are stored in the extended register.

In Example 16, the subject matter of Examples 9-15, wherein the first register and the extended register identify different registers located in the plurality of registers.

Various embodiments may have different combinations of the structural features described above. For instance, all optional features of the processors and methods described above may also be implemented with respect to a system described herein and specifics in the examples may be used anywhere in one or more embodiments.

Example 17 is a system on chip (SoC) comprising: 1) a memory controller unit (MCU); and 2) a processor, operatively coupled to the MCU, to: a) receive an instruction to be executed by the processor, wherein the instruction is associated with a binary translator operation to translate input instruction sequences to output instruction sequences; and b) identify, within the instruction, an opcode prefix referencing an extended register of a plurality of registers to be used during the binary translator operation, wherein the extended register preserves a source register value of the plurality of registers.

In Example 18, the subject matter of Example 17, wherein the processor further to determine whether the opcode prefix associated with the binary translator operation is valid in view of a capability of the processing system.

In Example 19, the subject matter of Examples 17-18, wherein the processor further to, responsive to determining that the opcode prefix is invalid, generate an alert indicating that the binary translator operation cannot be performed by the processing system.

In Example 20, the subject matter of Examples 17-19, wherein the processor further to: a) identify a first register of the plurality of registers in view the opcode prefix; and b) perform the binary translator operation using data stored in the first register.

In Example 21, the subject matter of Examples 17-20, wherein the first register comprises an address associated with an execution of the instruction.

In Example 22, the subject matter of Examples 17-21, wherein the binary translator operation comprises an arithmetic operation using a value stored in the first register.

In Example 23, the subject matter of Examples 17-22, wherein results of the arithmetic operation are stored in the extended register.

In Example 24, the subject matter of Examples 17-23, wherein the first register and the extended register identify different registers located in the plurality of registers.

Various embodiments may have different combinations of the operational features described above. For instance, all optional features of the methods described above may also be implemented with respect to a non-transitory, computer-readable storage medium. Specifics in the examples may be used anywhere in one or more embodiments

Example 25 is a non-transitory computer readable storage medium storing executable instructions, that when executed cause a processing device to: a) receive, by the processing device, an instruction to be executed by the processor device, wherein the instruction is associated with a binary translator operation to translate input instruction sequences to output instruction sequences; and b) identify, within the instruction, an opcode prefix referencing an extended register of a plurality of registers to be used during the binary translator operation, wherein the extended register preserves a source register value of the plurality of registers.

In Example 26, the subject matter of Example 25, wherein the executable instructions further cause the processor device to determine whether the opcode prefix associated with the binary translator operation is valid in view of a capability of the processing system.

In Example 27, the subject matter of Examples 25-26, wherein the executable instructions further cause the processor device to, responsive to determining that the opcode prefix is invalid, generate an alert indicating that the binary translator operation cannot be performed by the processing system.

In Example 28, the subject matter of Examples 25-27, wherein the executable instructions further cause the processor device to: a) identify a first register of the plurality of registers in view the opcode prefix; and b) perform the binary translator operation using data stored in the first register.

In Example 29, the subject matter of Examples 25-28, wherein the first register comprises an address associated with an execution of the instruction.

In Example 30, the subject matter of Examples 25-29, wherein the binary translator operation comprises an arithmetic operation using a value stored in the first register.

In Example 31, the subject matter of Examples 25-30, wherein results of the arithmetic operation are stored in the extended register.

In Example 32, the subject matter of Examples 25-31, wherein the first register and the extended register identify different registers located in the plurality of registers.

Example 33 is a non-transitory, computer-readable storage medium including instructions that, when executed by a processor, cause the processor to perform the method of examples 9-16.

Various embodiments may have different combinations of the operational features described above. For instance, all optional features of the methods, systems and non-transitory, computer-readable storage mediums described above may also be implemented with respect to other type of structures. Specifics in the examples may be used anywhere in one or more embodiments.

Example 34 is an apparatus comprising: 1) a plurality of functional units of a processor; 2) means for receiving, by a processor, an instruction to be executed by the processor, the instruction is associated with a binary translator operation to translate input instruction sequences to output instruction sequences; and 3) means for identifying, within the instruction, an opcode prefix referencing an extended register of a plurality of registers to be used during the binary translator operation, wherein the extended register preserves a source register value of the plurality of registers.

In Example 35, the subject matter of Example 34, further comprising the subject matter of any of examples 1-8 and 17-24.

Example 36 is a system comprising: 1) a memory device and 2) a processor comprising a memory controller unit, wherein the processor is configured to perform the method of any of examples 9-16.

In Example 37, the subject matter of Example 36, further comprising the subject matter of any of examples 1-8 and 17-24.

Example 38 is a processing system comprising: 1) a register bank having a plurality of registers to store data for use in executing instructions; and 2) a processor core, operatively coupled to the register bank, to: a) receive an instruction to be executed by the processor core, wherein the instruction is for a conditional branch operation associated with a binary translator; and b) identify, within the instruction, an opcode prefix referencing an extended register of the plurality of registers to be used during the conditional branch operation, wherein the extended register stores a conditional input value identifying a condition for the conditional branch operation.

In Example 39, the subject matter of Example 38, wherein the processor core further to determine whether to bypass or execute the instruction in view of the conditional input value.

Example 40 is a method, comprising: 1) receiving, by a processor, an instruction to be executed by the processor, wherein the instruction is for a conditional branch operation associated with a binary translator; and 2) identifying, within the instruction, an opcode prefix referencing an extended register of a plurality of registers to be used during the conditional branch operation, wherein the extended register stores a conditional input value identifying a condition for the conditional branch operation.

In Example 41, the subject matter of Example 40, further comprising determining whether to bypass or execute the instruction in view of the conditional input value.

Example 42 is a system on chip (SoC) comprising: 1) a memory controller unit (MCU); and 2) a processor, operatively coupled to the MCU, to: a) receive an instruction to be executed by the processor, wherein the instruction is for a conditional branch operation associated with a binary translator; and b) identify, within the instruction, an opcode prefix referencing an extended register of a plurality of registers to be used during the conditional branch operation, wherein the extended register stores a conditional input value identifying a condition for the conditional branch operation.

In Example 43, the subject matter of Example 42, wherein the processor further to determine whether to bypass or execute the instruction in view of the conditional input value.

Example 44 is a non-transitory computer readable storage medium storing executable instructions, that when executed cause a processing device to: a) receive, by the processing device, an instruction to be executed by the processing device, wherein the instruction is for a conditional branch operation associated with a binary translator; and b) identify, within the instruction, an opcode prefix referencing an extended register of a plurality of registers to be used during the conditional branch operation, wherein the extended register stores a conditional input value identifying a condition for the conditional branch operation.

In Example 45, the subject matter of Example 44, wherein the executable instructions further cause the processing device to determine whether to bypass or execute the instruction in view of the conditional input value.

Example 46 is a non-transitory, computer-readable storage medium including instructions that, when executed by a processor, cause the processor to perform the method of examples 40-41.

Example 47 is an apparatus comprising: 1) a plurality of functional units of a processor; 2) means for receive an instruction to be executed by the processor, wherein the instruction is for a conditional branch operation associated with a binary translator; and 3) means for identifying, within the instruction, an opcode prefix referencing an extended register of a plurality of registers to be used during the conditional branch operation, wherein the extended register stores a conditional input value identifying a condition for the conditional branch operation.

In Example 48, the subject matter of Example 47, further comprising the subject matter of any of examples 38-39 and 42-43.

Example 49 is a system comprising: a memory device and a processor comprising a memory controller unit, wherein the processor is configured to perform the method of any of examples 40-41.

In Example 50, the subject matter of Example 49, further comprising the subject matter of any of examples 38-39 and 42-43.

Example 51 is a processing system comprising: 1) a register bank having a plurality of registers to store data for use in executing instructions; and 2) a processor core, operatively coupled to the register bank, to: a) receive an instruction to be executed by the processor core, wherein the instruction is for a reordering operation associated with a binary translator; and b) identify, within the instruction, an opcode prefix referencing an extended register of the plurality of registers to be used during the reordering operation, wherein the extended register stores an address of a different instruction indicating a reordering of an execution of the instruction with respect to the different instruction.

In Example 52, the subject matter of Example 51, wherein the processor core further to determine whether the reordering is valid in view of a first address associated with the instruction and the address of the different instruction stored in the extended register.

Example 53 is a method, comprising: 1) receiving, by a processor, an instruction to be executed by the processor, wherein the instruction is for a reordering operation associated with a binary translator; and 2) identifying, within the instruction, an opcode prefix referencing an extended register of the plurality of registers to be used during the reordering operation, wherein the extended register stores an address of a different instruction indicating a reordering of an execution of the instruction with respect to the different instruction.

In Example 54, the subject matter of Example 53, wherein furthering comprising determining whether the reordering is valid in view of a first address associated with the instruction and the address of the different instruction stored in the extended register.

Example 55 is a system on chip (SoC) comprising: 1) a memory controller unit (MCU); and 2) a processor, operatively coupled to the MCU, to: a) receive an instruction to be executed by the processor, wherein the instruction is for a reordering operation associated with a binary translator; and b) identify, within the instruction, an opcode prefix referencing an extended register of a plurality of registers to be used during the reordering operation, wherein the extended register stores an address of a different instruction indicating a reordering of an execution of the instruction with respect to the different instruction.

In Example 56, the subject matter of Example 55, wherein the processor further to determine whether the reordering is valid in view of a first address associated with the instruction and the address of the different instruction stored in the extended register.

Example 57 is a non-transitory computer readable storage medium storing executable instructions, that when executed cause a processing device to: 1) receive, by the processing device, an instruction to be executed by the processing device, wherein the instruction is for a reordering operation associated with a binary translator; and 2) identify, within the instruction, an opcode prefix referencing an extended register of a plurality of registers to be used during the reordering operation, wherein the extended register stores an address of a different instruction indicating a reordering of an execution of the instruction with respect to the different instruction.

In Example 58, the subject matter of Example 57, wherein the executable instructions further cause the processor device to determine whether the reordering is valid in view of a first address associated with the instruction and the address of the different instruction stored in the extended register.

Example 59 is a non-transitory, computer-readable storage medium including instructions that, when executed by a processor, cause the processor to perform the method of examples 53-54.

Example 60 is an apparatus comprising: 1) a plurality of functional units of a processor; 2) means for receiving an instruction to be executed by the processor, wherein the instruction is for a reordering operation associated with a binary translator; and 3) means for identifying, within the instruction, an opcode prefix referencing an extended register of a plurality of registers to be used during the reordering operation, wherein the extended register stores an address of a different instruction indicating a reordering of an execution of the instruction with respect to the different instruction.

In Example 61, the subject matter of Example 60, further comprising the subject matter of any of examples 51-52 and 55-56.

Example 62 is a system comprising: 1) a memory device and a processor comprising a memory controller unit, wherein the processor is configured to perform the method of any of examples 53-54.

In Example 63, the subject matter of Example 62, further comprising the subject matter of any of examples 51-52 and 55-56.

While the disclosure has been described with respect to a limited number of embodiments, those skilled in the art will appreciate numerous modifications and variations there from. It is intended that the appended claims cover all such modifications and variations as fall within the true spirit and scope of this disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 910 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A processing system comprising:
a register bank having a plurality of registers to store data for use in executing instructions; and
a processor core, operatively coupled to the register bank, to:
receive an instruction to be executed by the processor core, wherein the instruction is associated with a binary translator operation to translate input instruction sequences to output instruction sequences; and
identify, within the instruction, an opcode prefix referencing an extended register of the plurality of registers to be used during the binary translator operation, wherein the extended register preserves a source register value of the plurality of registers.

2. The processing system of claim 1, wherein the processor core further to determine whether the opcode prefix associated with the binary translator operation is valid in view of a capability of the processing system.

3. The processing system of claim 1, wherein the processor core further to, responsive to determining that the opcode prefix is invalid, generate an alert indicating that the binary translator operation cannot be performed by the processing system.

4. The processing system of claim 1, wherein the processor core further to:
identify a first register of the plurality of registers in view the opcode prefix; and
perform the binary translator operation using data stored in the first register.

5. The processing system of claim 4, wherein the first register comprises an address associated with an execution of the instruction.

6. The processing system of claim 4, wherein the binary translator operation comprises an arithmetic operation using a value stored in the first register.

7. The processing system of claim 6, wherein results of the arithmetic operation are stored in the extended register.

8. The processing system of claim 7, wherein the first register and the extended register identify different registers located in the plurality of registers.

9. A method, comprising:
receive, by a processor, an instruction to be executed by the processor, the instruction is associated with a binary translator operation to translate input instruction sequences to output instruction sequences; and
identify, within the instruction, an opcode prefix referencing an extended register of a plurality of registers to be used during the binary translator operation, wherein the extended register preserves a source register value of the plurality of registers.

10. The method claim 9, further comprising determining whether the opcode prefix associated with the binary translator operation is valid in view of a capability of the processor.

11. The method claim 10, further comprising determining responsive to determining that the opcode prefix is invalid, generating an alert indicating that the binary translator operation cannot be performed by the processor.

12. The method claim 9, wherein further comprising:
identifying a first register of the plurality of registers in view the opcode prefix; and
perform the binary translator operation using data stored in the first register.

13. The method claim 12, wherein the first register comprises an address associated with an execution of the instruction.

14. The method claim 12, wherein the binary translator operation comprises an arithmetic operation using a value stored in the first register.

15. The method claim 14, wherein results of the arithmetic operation are stored in the extended register.

16. The method claim 15, wherein the first register and the extended register identify different registers located in the plurality of registers.

17. A processing system comprising:
a register bank having a plurality of registers to store data for use in executing instructions; and
a processor core, operatively coupled to the register bank, to:
receive an instruction to be executed by the processor core, wherein the instruction is for a conditional branch operation associated with a binary translator; and
identify, within the instruction, an opcode prefix referencing an extended register of the plurality of registers to be used during the conditional branch operation, wherein the extended register stores a conditional input value identifying a condition for the conditional branch operation.

18. The processing system of claim 17, wherein the processor core further to determine whether to bypass or execute the instruction in view of the conditional input value.

19. A processing system comprising:
a register bank having a plurality of registers to store data for use in executing instructions; and
a processor core, operatively coupled to the register bank, to:
receive an instruction to be executed by the processor core, wherein the instruction is for a reordering operation associated with a binary translator; and
identify, within the instruction, an opcode prefix referencing an extended register of the plurality of registers to be used during the reordering operation, wherein the extended register stores an address of a different instruction indicating a reordering of an execution of the instruction with respect to the different instruction.

20. The processing system of claim 19, wherein the processor core further to determine whether the reordering is valid in view of a first address associated with the instruction and the address of the different instruction stored in the extended register.
